(19) United States
(12) Patent Application Publication
(10) Pub. No.: US 2024/0406550 A1
(43) Pub. Date: Dec. 5, 2024

(54) FRONT-END IMAGE PREPROCESSING

(71) Applicant: Microsoft Technology Licensing, LLC, Redmond, WA (US)

(72) Inventors: Tuomas Sakari JARVINEN, Tampere (FI); Mikko Henrik SIMONEN, Tampere (FI)

(73) Assignee: Microsoft Technology Licensing, LLC, Redmond, WA (US)

(21) Appl. No.: 18/326,414

(22) Filed: May 31, 2023

(51) Int. Cl. H04N 23/65; H04N 23/611; H04N 23/84

(52) U.S. Cl. CPC H04N 23/651; H04N 23/611; H04N 23/84

(57) ABSTRACT

Examples are disclosed that relate to front-end image preprocessing. One example provides a computing device comprising an image sensor, an image signal processor, and a front-end preprocessor disposed electrically between the image sensor and image signal processor. The computing device further comprises a storage subsystem comprising instructions executable by a logic subsystem to receive a first image from the image sensor at the preprocessor, preprocess the first image to produce a quantification of first image content, receive a second image, preprocess the second image to produce a quantification of second image content, compare the second quantification to the first quantification to determine a difference, and responsive to the difference satisfying a threshold condition, cause an operating state of a component of the computing device to be changed.

### BACKGROUND

Some computing devices continuously capture image data to detect the presence of a user within the field of view of an image sensor. In some examples, the image sensor can be used to collect biometric data regarding the user to identify the user—e.g., for logging into a user account or conducting an online transaction. The continuous capture of image data, however, consumes power and computational resources during time periods where no users are present.

### SUMMARY

Examples are disclosed that relate to the use of a front-end image preprocessor to monitor for changes in image data acquired by an image sensor. One example provides a computing device comprising an image sensor, an image signal processor, and a front-end preprocessor disposed electrically between the image sensor and image signal processor. The computing device further comprises a storage subsystem comprising instructions executable by a logic subsystem to receive a first image from the image sensor at the preprocessor, preprocess the first image to produce a quantification of first image content, receive a second image, preprocess the second image to produce a quantification of second image content, compare the second quantification to the first quantification to determine a difference, and responsive to the difference satisfying a threshold condition, cause an operating state of a component of the computing device to be changed.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIGS. 1A-1C illustrate an example of user presence detection at a computing device.

FIG. 2 depicts a block diagram of an example computing device comprising an image preprocessor.

FIGS. 3A-3C schematically depicts example image content quantifications.

FIGS. 4A-4B depicts a flowchart illustrating an example method of preprocessing images.

FIG. 5 depicts a block diagram of an example computing system.

### DETAILED DESCRIPTION

As mentioned above, some computing devices continuously capture image data to detect the presence of a user within the field of view of an image sensor. In some examples, the image sensor can be used to collect biometric data regarding the user to identify the user—e.g., for logging into a user account and/or conducting an online transaction. The continuous capture and processing of image data, however, consumes power and computational resources, which is inefficient when no users are present. This issue is exacerbated where image frames from high-resolution image sensors with high pixel counts are analyzed. Further, approaches that analyze image frames can pose privacy and security concerns. For example, a third-party who obtains unauthorized access to an operating system may gain the ability to access image frames. Some approaches provide an auxiliary image signal processor in addition to a primary image signal processor, where the auxiliary processor is tasked with analyzing image frames to detect user presence. However, as the auxiliary processor may duplicate some of the functionality of the primary processor, the inclusion of both processors can produce redundancy in the physical configuration of a computing device. Another approach augments an image sensor itself with user presence detection and other image analysis functionality, but at the cost of increased sensor die area, complexity, and power consumption.

In view of the above, examples are disclosed that relate to the use of a front-end preprocessor configured to preprocess image data from one or more image sensors. In one example, the front-end preprocessor preprocesses a first image to produce a quantification of content of the first image, and preprocesses a second image to produce a quantification of content of the second image. The front-end preprocessor then compares the quantification of first image content to the quantification of second image content to determine a difference. Where the difference satisfies a threshold condition, the front-end preprocessor causes a power state of a component of the computing device to be changed from a lower power state to a higher power state. For example, the power state of an image signal processor can be raised from a sleep or idle state to an operating state.

As described below, quantifications of image content produced by the front-end preprocessor can quantify the content of an image in a variety of ways. For example, pixel intensity values can be computationally combined, such as by being summed. In the case of a color image sensor, such summing can be performed for one or more color channels (e.g. red, green and/or blue color channels). As another example, an image can be quantified by converting to a YUV or other color space, and then summing luminance and/or chrominance values. In some examples, a subset of pixels of the image can be quantified, instead of or in addition to an entire image. Accordingly, comparisons of image content among different images, and the detection of conditions that invoke a higher power state of an image signal processor, can be performed with lower power and computational cost as compared to approaches that analyze full image frames or process raw pixel values. Further, the quantifications represent image data content, but in non-image data format. This can allow comparison of images while providing for enhanced security and privacy over approaches that analyze image frames. Still further, in some examples, a microcontroller unit (MCU) separate from a central processing unit (CPU) can be provided that controls the front-end preprocessor. This can further enhance security by separating access to image data quantifications from the CPU and operating systems executing on the CPU.

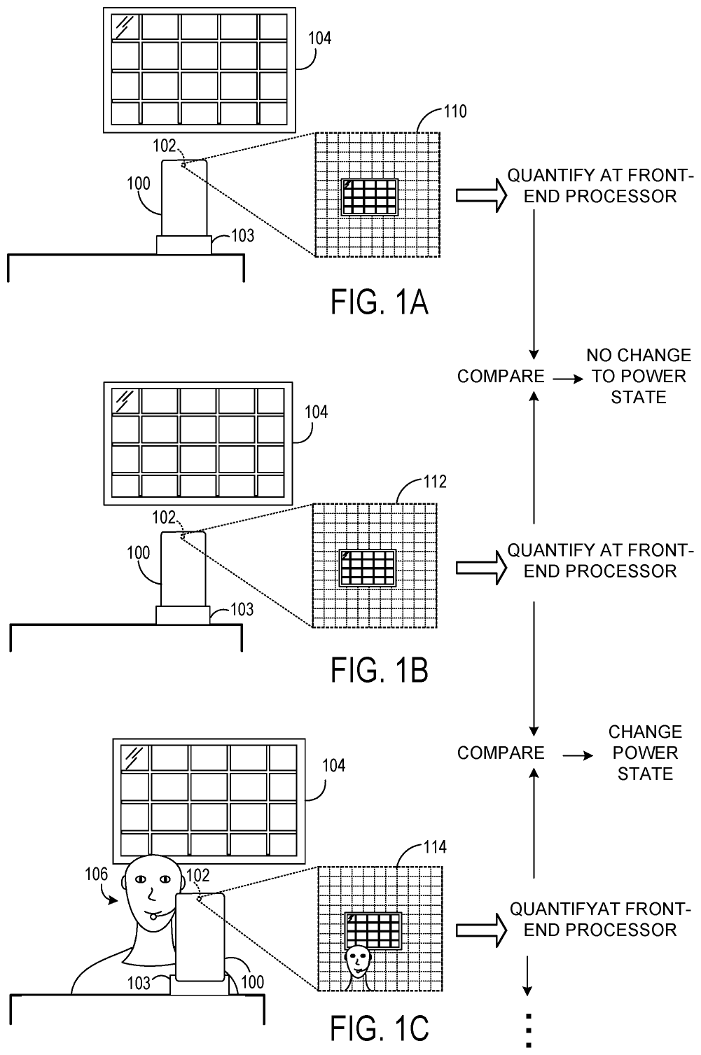

FIGS. 1A-1C depict an example scenario in which a computing device 100 uses an image sensor 102 to capture image data to detect a presence of a person. Computing device 100 is depicted as a mobile computing device (e.g., smartphone), but can assume other mobile form factors (e.g., laptop, tablet) or non-mobile form factors (e.g., desktop). Further, image sensor 102 is depicted as being integrated within the body of computing device 100, but can be implemented as a peripheral connected to the computing device in other examples.

Computing device 100 includes a front-end preprocessor configured to preprocess images from image sensor 102 to identify threshold changes in successive images that prompt additional image processing by an image signal processor. As described below, the front-end preprocessor produces a quantification of content in an image by computationally combining pixel values. In some examples, image content can be quantified by summing pixel intensity values for one or more color channels (e.g. red, green, and/or blue). In other examples, a different computation than summing can be performed, such as multiplying. As another example, an image can be converted to a different color space (e.g. YUV), and luminance and/or chrominance value(s) for the image in the different color space can be computationally combined. In some examples, a subset of pixels of the image (e.g., selected rows, columns, two-dimensional regions) can be computationally combined to quantify the content of the image.

For successive images, the front-end preprocessor can determine a difference between a first quantification of image content of a first image and a second quantification of image content of a second image. This difference can be compared to a threshold condition (e.g., threshold value or threshold change) to determine whether to invoke a higher power state of the image signal processor for further image processing. The higher power state can comprise, for example, detecting whether a user is present within the field of view of image sensor 102.

In the example depicted in FIGS. 1A-1B, the mobile device 100 is positioned on a stand 103 facing window 104. The front-end preprocessor quantifies content in a first image 110 and stores the quantification at the front-end preprocessor. The front-end preprocessor then quantifies content in a second image 112, and compares the quantification of the first image 110 to the quantification of the second image 112. In this example, first and second images 110 and 112 are successive images in a stream of images captured by image sensor 102. As the images are not significantly different, the difference does not satisfy a threshold condition established for invoking a higher power state of the image signal processor for further image processing. The comparison can take into account differences between images that may not be representative of a person entering the image frame (e.g. changes in brightness, such as by lighting becoming dimmer or brighter, that affect pixels of an image).

In FIG. 1C, user 106 enters the field of view of the image sensor 102, resulting in significantly different quantifications of image content of a third image 114 compared to the second image 112. The front-end preprocessor determines that the difference exceeds a threshold change and thus satisfies the threshold condition established for operating the image signal processor. Accordingly, the front-end preprocessor causes the power state of the image signal processor to be raised from a lower power state to a higher power state. In this higher power state, the image signal processor can process images captured by image sensor 102 to detect the presence of user 106, among other potential image processing tasks.

Presence detection, and potentially other image processing tasks performed by the image signal processor, can be significantly more expensive than the image preprocessing performed by the front-end preprocessor to identify threshold changes among images. As examples, presence detection can involve processing full image frames at higher resolutions and/or framerates, and/or raw pixel values. In contrast, front-end image preprocessing produces and operates on quantifications of image content that are reduced in size relative to raw image data content. Image preprocessing can also be carried out at lower resolutions and/or framerates as compared to image processing performed by the image signal processor.

As mentioned above, an image content quantification is a computational combination of pixel values. Example computational combinations include summing and multiplying. In some examples, pixels in a subregion of an image can be used to quantify an image. This can be more computationally efficient than quantifying an image by using all pixels of the image. In this way, image content can be quantified in a relatively compact representation, enabling image preprocessing using lesser amounts of image data. Further, the quantification can be stored for comparison with a subsequent quantification without storing image frames or data in image data formats that can pose user privacy issues if accessed directly.

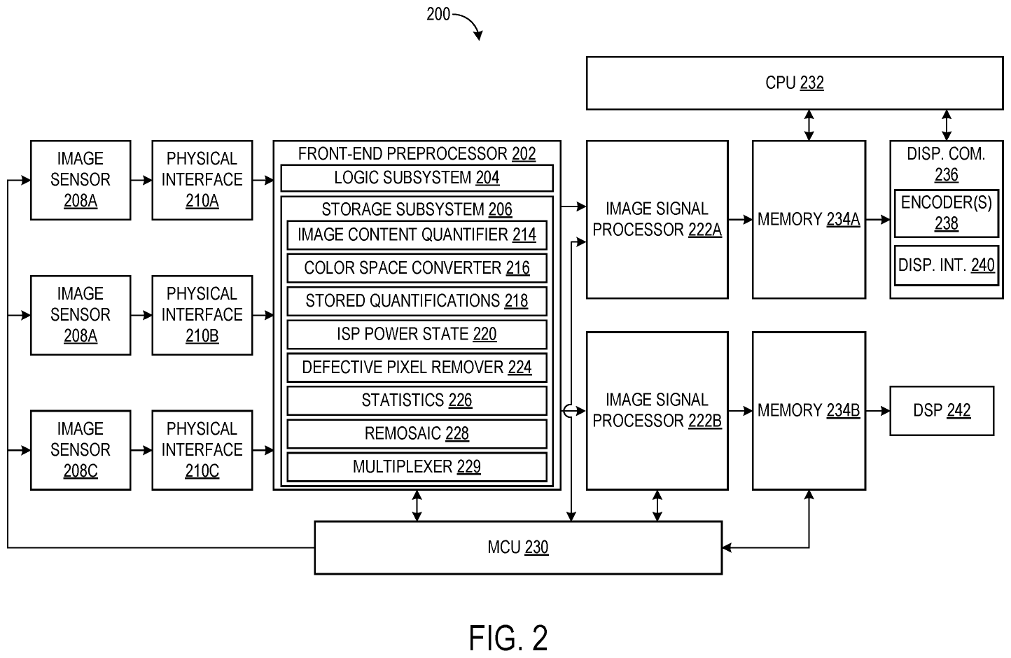

FIG. 2 depicts a block diagram of an example computing device 200 implementing a front-end preprocessor 202 configured to preprocess image data. Computing device 100 can implement aspects of computing device 200, for example.

Front-end preprocessor 202 includes a logic subsystem 204 and a storage subsystem 206 that stores executable modules that perform various image processing-related tasks such as quantifying image content. Front-end preprocessor 202 receives image data from image sensors via corresponding physical interfaces connected to the image sensor. In the depicted example, three image sensors 208A, 208B, 208C and three corresponding physical interfaces 210A, 210B, 210C are included in computing device 200. The image sensors 208A, 208B, 208C can be, for example, a world-facing color image sensor, a user-facing color image sensor, and a user-facing infrared image sensor. In some examples, a mobile device can have a different set of image sensors, including other types of image sensors and/or a different number of image sensors. Other examples of image sensors include depth image sensors (e.g. time of flight cameras or structured light cameras) and monochromatic image sensors.

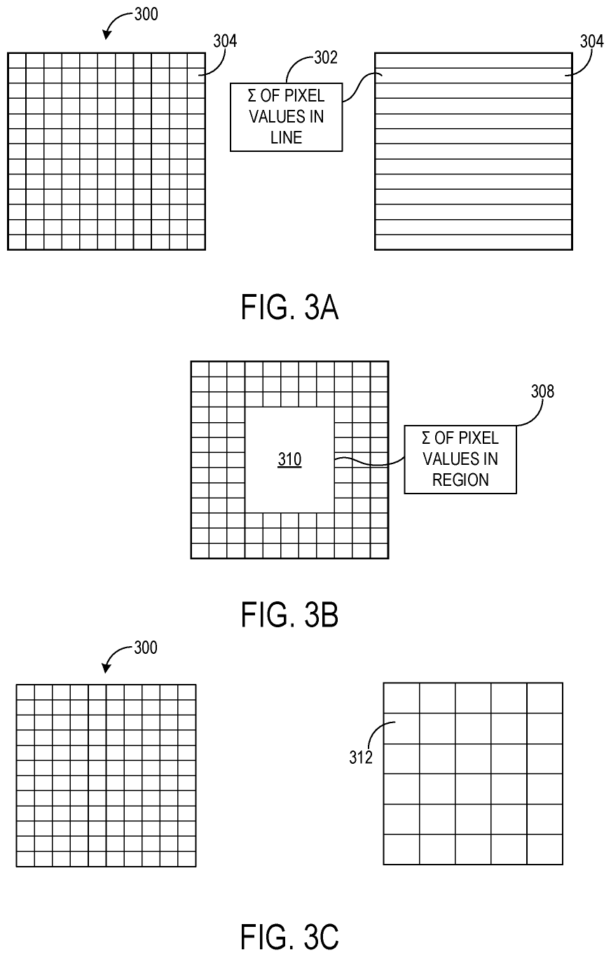

Storage subsystem 206 includes an image content quantifier module 214 executable to produce a quantification of content of an image captured by an image sensor 208. As noted above, an image content quantification can include a computational combination of pixel values, such as luminance values, chrominance values, and/or color channel intensity value(s) for selected region(s) of an image. As an example, FIG. 3A schematically depicts an image 300, and a quantification 302 produced by summing (2) pixel values in line 304 of image 300. In some examples, quantification 302 can be determined by converting color channel values of image 300 to a YUV or other luminance/chrominance color space, and then summing or otherwise computationally combining the luminance values of the pixels in line 304. In other examples, quantification 302 can comprise a sum or other computational combination of chrominance values for the pixels in the line of pixels, alternatively or in addition to the sum of the luminance values. In further examples, quantification 302 can comprise a sum or other computational combination of pixel values for intensities in one or more RGB color channels. In further examples, quantifications can be for a group of lines, such as for adjacent pairs of lines, odd numbered lines with even numbered lines omitted, or even numbered lines with odd numbered lines omitted. Further, quantifications can be produced for columns in image 300, alternatively or additionally to quantifications produced for rows. While the depicted examples show image content being quantified by summing pixel values, in other examples, any other suitable computational combination of pixel values can be determined, including but not limited to multiplying pixel values.

As another example, FIG. 3B depicts an example quantification 308 of a two-dimensional region 310 of image 300 produced by summing (2) pixel values from pixels within a two-dimensional region. The depicted quantification 308 comprises summed pixel values for pixels in region 310. In other examples, other suitable computational combinations can be done. In some examples, multiple two-dimensional regions can be formed and quantifications of image content produced for each region.

In other examples, subsets of pixels to use for quantification can be determined in other manners than by line or by area. For example, quantifications can be produced for pixels that have pixel values greater than a threshold pixel value (e.g., greater than a threshold luminance, chrominance value or color channel intensity value. In some such examples, such pixels can form non-rectangular region(s) and/or multiple, disconnected regions. Quantifications can be produced for yet other two-dimensional regions. Examples include even numbered pixels/lines/columns, odd numbered pixels/lines/columns, and checkerboard and/other patterns.

FIG. 3C depicts another example method of quantifying the content of image 300. In this example, the amount of image data used to produce quantifications is reduced by binning pixels in the image. Here, groups of four adjacent pixels are binned together to form a binned pixel (e.g., binned pixel 312). The value of the binned pixel then can be used to compute the quantification of the image content. In other examples, any suitable number of pixels can be binned, including binning some regions of image 300 and not others. In yet other examples, quantifications can be produced for the two-dimensional extent of image 300 without binning pixels in the image. Here, the use of image content quantifications, however, can reduce image data used in preprocessing as compared to processing raw pixel values.

As mentioned above, quantifying image content can include converting between different color spaces in some examples. Returning to FIG. 2, storage subsystem 206 of front-end preprocessor 202 includes a color space converter module 216 configured to convert an image received from an image sensor 208 from a first color space to a second color space. Color space conversion can include converting from an RGB color space (e.g., in which image sensor 208 outputs images) to a YUV color space or other luminance/chrominance color space, for example. In some implementations, front-end preprocessor 202 can utilize color space converter module 216 to convert an image from a first color space (e.g., RGB color space) to a second color space to obtain luminance values (e.g., a luma component in a YUV color space) for the image. Front-end preprocessor 202 can then utilize image content quantifier module 214 to produce a quantification of the luminance values. As another example, color space converter module 216 can be used to compute chrominance value(s) from images in an RGB color space that provides color values in each of red/green/blue color channels.

Storage subsystem 206 holds stored image content quantification(s) 218 computed via image content quantifier module 214. Storage subsystem 206 can store a prior quantification for comparison to a current quantification. Following the comparison, the prior quantification can be retained or removed, and the current quantification can be stored for a subsequent comparison. As described above, quantifications 218 are computational combinations of pixel values. In some examples, quantifications 218 can quantify subregions of an image, alternatively or additionally to a full image. Pixel values and other frame data can be discarded by front-end preprocessor 202 and not stored at storage subsystem 206. In this way, raw pixel values or other frame data from which the content of an image can otherwise be reconstructed are not stored at storage subsystem 206 or memory in the computing system. Instead, image content quantifications 218 comprise non-image formats, such as a single value for the image, one or more values each corresponding to a quantification of a sub-region of the image, etc. The storage of image content quantifications 218 and not image frames or raw pixel values further can reduce the amount of image data stored at storage subsystem 206 as compared to storing image frames, as well as enhance privacy and security.

Storage subsystem 206 further includes an image signal processor power state module 220 configured to determine when to signal an image signal processor 222 to change a power state based on comparing image content quantifications. For example, using image content quantifier module 214, front-end preprocessor 202 can preprocess a first image from an image sensor 208 to produce a quantification of content of the first image, and preprocess a second image from the image sensor to produce a quantification of content of the second image. The first and second images can be successive images in a stream of images captured by image sensor 208, for example. Using power state module 220, front-end preprocessor 202 can compare the quantification of content of the first image to the quantification of content of the second image to determine a difference, and compare the difference to a threshold condition (e.g., threshold change in quantified value, threshold magnitude of quantified value). Where the difference satisfies the threshold condition (e.g., meets or exceeds the threshold change and/or threshold magnitude), front-end preprocessor can use power state module 220 to cause the power state of an image signal processor 222 to be changed from a lower power state to a higher power state. Any suitable power state transition can be performed. Examples include transitioning from an idle or rest state to an operational state in which image signal processor carries out various image processing tasks, such as user presence detection and/or biometric identification. Image signal processor 222 may be clock-gated and/or powered down in the lower power state, for example. Further, in some examples transitioning the power state of an image signal processor 222 can include taking actions at other components of computing device 200, such as invoking a software and/or hardware function at a central processing unit of the computing device related to image processing or the operation of an image processing component. Yet other components can undergo transitions in operational states—for example, one or more image sensors 208 can be operated in a lower power state in which image data is captured at lower resolutions and/or framerates, and transitioned to a higher power state (in response to satisfaction of the threshold condition/detecting user presence) in which image data is captured at relatively higher resolutions and/or framerates.

In some examples, the quantification of image content and comparison of quantifications can continue after identifying the presence of a user via presence detection. Through comparison of image content quantifications, and potentially in combination with observing activity at computing device 200, the absence of a user can be detected. Various computing device actions can be taken in response, such as reducing the power state of computing device 200, locking the computing device, and/or signing the user out of a user account. As an example of detecting user absence, front-end preprocessor 202 can preprocess a third image from an image sensor 208 to produce a quantification of content of the third image, and preprocess a fourth image from the image sensor to produce a quantification of content of the fourth image. In this example, the third and fourth images are captured after the first and second images described above, but are not contiguous with the first and second images. Using power state module 220, front-end preprocessor 202 can compare the quantification of content of the third image to the quantification of content of the fourth image to determine an updated difference, and compare the updated difference to the threshold condition. Where the updated difference does not satisfy the threshold condition (e.g., is below the threshold change and/or threshold magnitude), this can indicate that the user is no longer being imaged. As such, the front-end preprocessor 202 can use power state module 220 to cause the power state of an image signal processor 222 to be changed from the higher power state to the lower power state. In the lower power state, the image signal processor 222 can operate in an idle or sleep state, for example.

In some examples, the threshold condition against which differences in image content quantifications are compared can be predetermined (e.g. determined during computing device manufacture). In other examples, the threshold condition can be determined based on an image content quantification. This can include determinations made as part of a calibration procedure or nominal device operation. For example, the threshold condition can be determined based on one or both of a quantification of a first image and a quantification of a second image. As mentioned above, the threshold condition can include a threshold change and/or delta in quantified value among two or more images. Comparing differences in quantifications among different images may aid in the detection of rapid changes in image content among images, for example. Alternatively or in addition to a threshold change, the threshold condition can include a threshold absolute quantified value. Such an absolute value can be produced by summing, binning, or otherwise suitably combining pixel values. As an example, an image signal processor 222 may exit from a low power state into a higher power state upon a quantification of content in an image meeting or exceeding a predetermined threshold value. Further, in some examples absolute values can be determined for different lighting conditions and/or image content, while taking into account image sensor noise and drift, to obtain an expected range for an absolute value threshold. The use of an absolute value may aid in the detection of more gradual changes in image content among images, for example. Further, it will be understood that quantifications of image content, and differences among quantifications, can be computed for three or more images. Quantifications of image content and differences among quantifications can be computed for successive images and non-successive images in a sequence of images. Yet other quantification and comparison schemes are possible, including iterative and sliding window comparison schemes.

As mentioned above, operating in a higher power state invoked by front-end processor 202 can include detecting, using an image signal processor 222, the presence of a user in subsequent images captured by one or more image sensors 208. Presence detection can involve processing image data in an image data format, processing full image frames, and/or processing pixel values (e.g., non-quantifications in RGB or YUV color spaces), as examples. Further, an image signal processor 222 can perform other image processing tasks, alternatively or in addition to presence detection, including but not limited to face identification to identify and/or verify the identity of a user (e.g., for logging into or unlocking computing device 200, completing an online transaction). In other examples, presence detection and/or other tasks may be performed by another component than the image signal processor 22, such as by a CPU 232.

In the example depicted in FIG. 2, two image signal processors 218 are connected to front-end preprocessor 202. In some implementations, a first image signal processor 222A can be configured to perform a lower level (e.g., consuming less computational and/or power resources) of image processing, while a second image signal processor 222B can be configured to perform a higher level (e.g., consuming relatively more computational and/or power resources) of image processing. For example, the first image signal processor 222A can perform a first, lower level of user presence detection, while the second image signal processor 222B can perform a second, relatively higher level of user presence detection. In such examples, the first level of presence detection can be invoked by power state module 220 upon detecting a threshold change in image content. Image processing executed by the first image signal processor 222A as part of the first level of presence detection can evaluate image content and/or quantification(s) derived from image content and perform a comparison to a threshold condition. Where the threshold condition is satisfied, the second level of presence detection can be invoked at the second image signal processor 222B. In other examples, image signal processors 222A and 222B alternatively or additionally can be configured to perform any other suitable image processing task(s). As another example, the first image signal processor 222A can perform user presence detection, while the second image signal processor 222B can perform facial identification.

Storage subsystem 206 of front-end preprocessor 202 can include other modules. For example, storage system 206 can include a defective pixel remover module 224 configured to remove defective pixels from image data produced by image sensors 208. Alternatively or additionally, storage subsystem 206 can include a statistics module 226 configured to calculate statistics related to parameters such as exposure, focus, and white balance, where such statistics can be used to set corresponding settings at image sensors 208 (e.g., to avert sensor overflow). Further, storage subsystem 206 alternatively or additionally can include a remosaic module 228 configured to remosaic images from image sensors 208. Still further, storage subsystem 206 alternatively or additionally can include a multiplexer module 229 configured to multiplex image data from two or more image sensors to form multiplexed image data, and send the multiplexed image data to an image signal processor 222. Time-multiplexing and/or any other suitable multiplexing scheme can be used. It will be understood that such functionalities alternatively or additionally can be implemented at an image signal processor 222.

As shown in the example depicted in FIG. 2, front-end preprocessor 202 can be connected to and controlled by an MCU 230 separate from a CPU 232 implemented by computing device 200. In this control scheme, stored image content quantifications 218 can be inaccessible by CPU 232 and operating systems or applications executing on the CPU.

Each image signal processor 222 is connected to a respective memory pool 234. As one example, a first memory pool 234A is implemented as system random access memory, while a second memory pool 234B is implemented as secure memory. Further, the depicted example shows the connection of first memory pool 234A to display components 236 such as one or more encoders 238 (e.g., JPEG encoder, video encoder), and a display interface 240 configured to interface with a display integrated by computing device 200 or connected to the computing device. As further shown, second memory pool 234B can be connected to a digital signal processor 242. Digital signal processor 242 can implement a neural processing unit and/or other suitable signal processor(s). In other examples, any other suitable number and type of memory pools can be provided and connected to any suitable type of display component.

As shown in FIG. 2, front-end preprocessor 202 is positioned electrically between image sensors 208 and image signal processors 222. In one physical implementation, front-end preprocessor 202 can be implemented as a discrete component separate from image sensors 208, physical interfaces 210, and image signal processors 222, but on a common die with the physical interfaces and/or image signal processors. In other examples, front-end preprocessor 202, physical interfaces 210, and image signal processors 222 can be implemented on different dies in a common package, on different dies in different packages, or in any other suitable configuration.

Using the examples described above can reduce the consumption of computational and power resources compared to other methods of continuous image capture. The volume of data analyzed in image data preprocessing can be reduced by computing quantifications of image content, and potentially by quantifying subregions of images. Security and user privacy can be supported by the storage of quantifications in non-image-data formats, and by the separation of the front-end preprocessor from a CPU, system memory, or other component accessible by operating systems and applications.

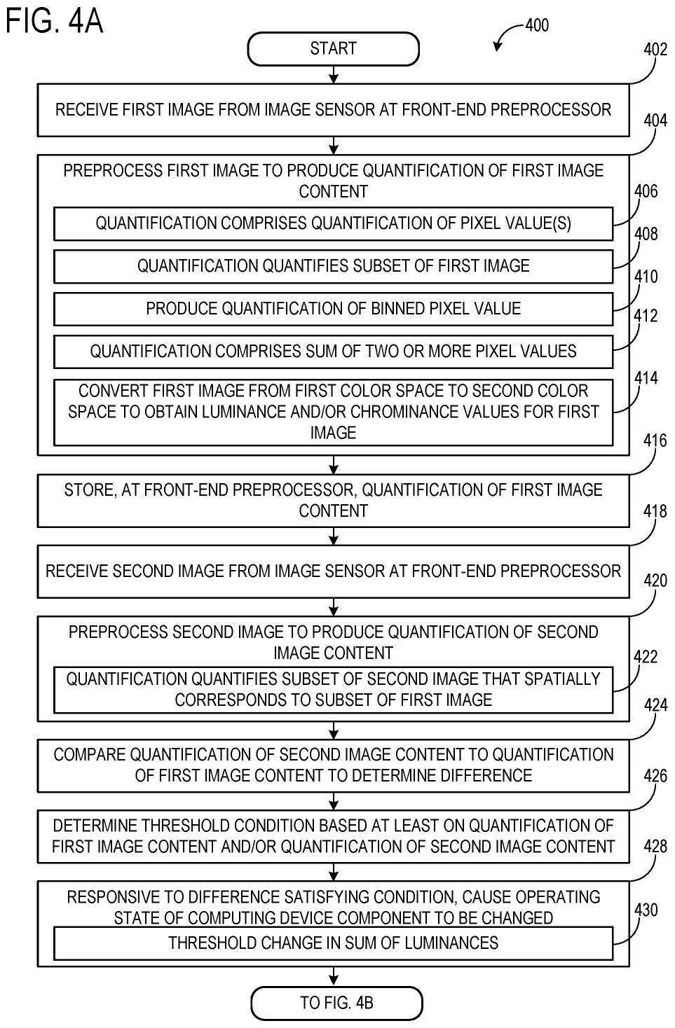

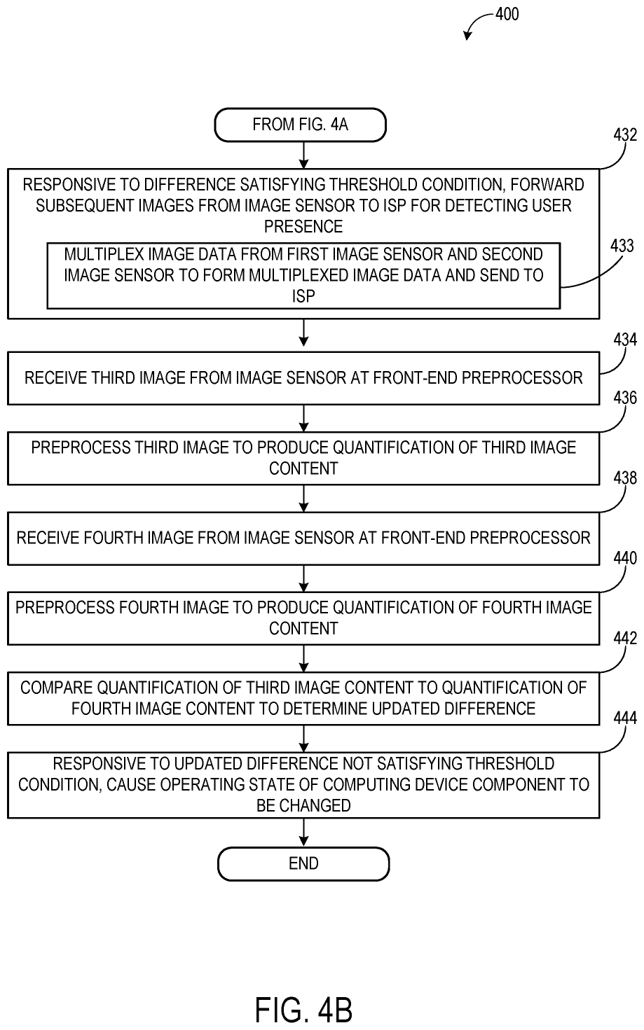

FIGS. 4A-4B depict a flowchart illustrating an example method 400 of preprocessing images using a front-end preprocessor as disclosed. Method 400 can be implemented by computing device 100 and/or computing device 200, for example.

At 402, method 400 includes receiving a first image from an image sensor. At 404, method 400 includes preprocessing the first image to produce a quantification of content of the first image. The quantification can comprise a quantification 406 of pixel value(s) in the image. As examples, pixel value(s) can include per-color-channel intensity values (e.g., RGB color intensity values), luminance values, and/or chrominance values. The quantification can quantify a subset 408 of the first image. In some examples, preprocessing the first image can include producing a quantification 410 of a binned pixel value formed by binning two or more pixels in the image. In some examples, the quantification can comprise a sum 412 of two or more pixel values. In other examples, the quantification can comprise another suitable computational combination of pixel values in the first image. Preprocessing the first image can include converting 414 the first image from a first color space to a second color space to obtain luminance and/or chrominance values for the first image.

At 416, method 400 includes storing, at the front-end preprocessor, the quantification of the content of the first image. At 418, method 400 includes receiving a second image from the image sensor at the frond-end preprocessor, and at 420, preprocessing the second image to produce a quantification of content of the second image. The quantification can quantify a subset 422 of the second image that spatially corresponds to the subset of the first image. The first and second images may be part of a stream of images captured by the image sensor, for example.

At 424, method 400 includes comparing the quantification of the content of the second image to the quantification of content of the first image to determine a difference. At 426, method 400 optionally includes determining the threshold condition based at least on the quantification of content of the first image and/or the quantification of content of the second image.

At 428, method 400 includes, responsive to the difference satisfying a threshold condition, causing an operating state of a component of the computing device to be changed. As one example, the power state of the image signal processor may be changed from a lower power state to a higher power state. The threshold condition can comprise a threshold change 430 in a sum of luminances, for example. Alternatively or additionally, the threshold condition can comprise a threshold change in a color value (e.g. chrominance or color channel intensity).

Continuing to FIG. 4B, at 432, method 400 optionally includes, responsive to the difference satisfying the threshold condition, forwarding subsequent images from the image sensor to the image signal processor for detecting user presence. In some examples, as indicated at 433, method 400 optionally includes multiplexing image data from first and second image sensors (and potentially additional image sensors) to form multiplexed image data, and sending the multiplexed image data to the image signal processor.

After identifying that the difference satisfies the threshold condition, and potentially after identifying user presence at the image signal processor, content in images captured after the first and second images can be quantified, and differences among such quantifications compared. This can include analysis of images captured immediately following capture of the second image, and/or analysis of images captured following one or more intervening images captured after the second image. Accordingly, at 434, method 400 optionally includes receiving a third image from the image sensor at the front-end preprocessor, and at 436, optionally preprocessing the third image to produce a quantification of content of the third image. At 438, method 400 optionally includes receiving a fourth image from the image sensor at the front-end preprocessor, and at 440, optionally preprocessing the fourth image to produce a quantification of content of the fourth image. At 442, method 400 optionally includes comparing the quantification of the content of the third image to the quantification of the content of the fourth image to determine an updated difference, and at 444, responsive to the updated difference not satisfying the threshold condition, optionally causing an operating state of a component of the computing device to be changed. As one example, the power state of the image signal processor may be lowered from the higher power state to the lower power state. The lack of satisfaction of the threshold condition can be interpreted as indicating a lack of user presence, with the power state of the image signal processor being lowered in response to the lack of user presence.

In some examples, the methods and processes described herein can be tied to a computing system of one or more computing devices. In particular, such methods and processes can be implemented as a computer-application program or service, an application-programming interface (API), a library, and/or other computer-program product.

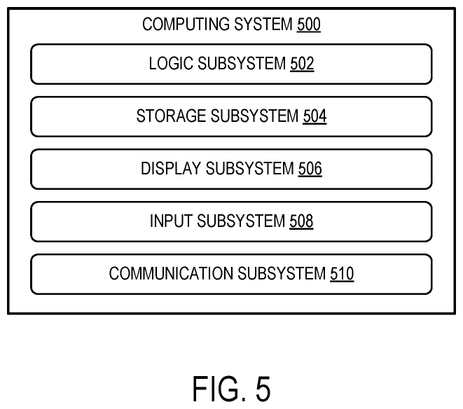

FIG. 5 schematically shows a non-limiting example of a computing system 500 that can enact one or more of the methods and processes described above. Computing system 500 is shown in simplified form. Computing system 500 can take the form of one or more personal computers, server computers, tablet computers, home-entertainment computers, network computing devices, gaming devices, mobile computing devices, mobile communication devices (e.g., smart phone), and/or other computing devices.

Computing system 500 includes a logic subsystem 502 and a storage subsystem 504. Computing system 500 can optionally include a display subsystem 506, input subsystem 508, communication subsystem 510, and/or other components not shown in FIG. 5.

Logic subsystem 502 includes one or more physical devices configured to execute instructions. For example, the logic subsystem can be configured to execute instructions that are part of one or more applications, services, programs, routines, libraries, objects, components, data structures, or other logical constructs. Such instructions can be implemented to perform a task, implement a data type, transform the state of one or more components, achieve a technical effect, or otherwise arrive at a desired result.

The logic subsystem can include one or more processors configured to execute software instructions. Additionally or alternatively, the logic subsystem can include one or more hardware or firmware logic subsystems configured to execute hardware or firmware instructions. Processors of the logic subsystem can be single-core or multi-core, and the instructions executed thereon can be configured for sequential, parallel, and/or distributed processing. Individual components of the logic subsystem optionally can be distributed among two or more separate devices, which can be remotely located and/or configured for coordinated processing. Aspects of the logic subsystem can be virtualized and executed by remotely accessible, networked computing devices configured in a cloud-computing configuration.

Storage subsystem 504 includes one or more physical devices configured to hold instructions executable by the logic subsystem to implement the methods and processes described herein. When such methods and processes are implemented, the state of storage subsystem 504 can be transformed—e.g., to hold different data.

Storage subsystem 504 can include removable and/or built-in devices. Storage subsystem 504 can include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage subsystem 504 can include volatile, nonvolatile, dynamic, static, read/write, read-only, random-access, sequential-access, location-addressable, file-addressable, and/or content-addressable devices.

It will be appreciated that storage subsystem 504 includes one or more physical devices. However, aspects of the instructions described herein alternatively can be propagated by a communication medium (e.g., an electromagnetic signal, an optical signal, etc.) that is not held by a physical device for a finite duration.

Aspects of logic subsystem 502 and storage subsystem 504 can be integrated together into one or more hardware-logic components. Such hardware-logic components can include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” can be used to describe an aspect of computing system 500 implemented to perform a particular function. In some cases, a module, program, or engine can be instantiated via logic subsystem 502 executing instructions held by storage subsystem 504. It will be understood that different modules, programs, and/or engines can be instantiated from the same application, service, code block, object, library, routine, API, function, etc. Likewise, the same module, program, and/or engine can be instantiated by different applications, services, code blocks, objects, routines, APIs, functions, etc. The terms “module,” “program,” and “engine” can encompass individual or groups of executable files, data files, libraries, drivers, scripts, database records, etc.

It will be appreciated that a “service”, as used herein, is an application program executable across multiple user sessions. A service can be available to one or more system components, programs, and/or other services. In some implementations, a service can run on one or more server-computing devices.

When included, display subsystem 506 can be used to present a visual representation of data held by storage subsystem 504. This visual representation can take the form of a graphical user interface (GUI). As the herein described methods and processes change the data held by the storage subsystem, and thus transform the state of the storage subsystem, the state of display subsystem 506 can likewise be transformed to visually represent changes in the underlying data. Display subsystem 506 can include one or more display devices utilizing virtually any type of technology. Such display devices can be combined with logic subsystem 502 and/or storage subsystem 504 in a shared enclosure, or such display devices can be peripheral display devices.

When included, input subsystem 508 can comprise or interface with one or more user-input devices such as a keyboard, mouse, touch screen, or game controller. In some examples, the input subsystem can comprise or interface with selected natural user input (NUI) componentry. Such componentry can be integrated or peripheral, and the transduction and/or processing of input actions can be handled on- or off-board. Example NUI componentry can include a microphone for speech and/or voice recognition; an infrared, color, stereoscopic, and/or depth camera for subsystem vision and/or gesture recognition; a head tracker, eye tracker, accelerometer, and/or gyroscope for motion detection and/or intent recognition.

When included, communication subsystem 510 can be configured to communicatively couple computing system 500 with one or more other computing devices. Communication subsystem 510 can include wired and/or wireless communication devices compatible with one or more different communication protocols. As non-limiting examples, the communication subsystem can be configured for communication via a wireless telephone network, or a wired or wireless local- or wide-area network. In some examples, the communication subsystem can allow computing system 500 to send and/or receive messages to and/or from other devices via a network such as the Internet.

Another example provides a computing device comprising an image sensor, an image signal processor, a front-end preprocessor disposed electrically between the image sensor and the image signal processor, a logic subsystem, and a storage subsystem comprising instructions executable by the logic subsystem to receive a first image from the image sensor at the front-end preprocessor, preprocess the first image to produce a quantification of content of the first image, receive a second image from the image sensor at the front-end preprocessor, preprocess the second image to produce a quantification of content of the second image, compare the quantification of the content of the second image to the quantification of content of the first image to determine a difference, and responsive to the difference satisfying a threshold condition, cause an operating state of a component of the computing device to be changed. In such an example, the operating state can be a power state of the image signal processor and can be changed from a lower power state to a higher power state, and the computing device can alternatively or additionally comprise instructions executable to receive a third image from the image sensor at the front-end preprocessor, preprocess the third image to produce a quantification of content of the third image, receive a fourth image from the image sensor at the front-end preprocessor, preprocess the fourth image to produce a quantification of content of the fourth image, compare the quantification of the content of the third image to the quantification of the content of the fourth image to determine an updated difference, and responsive to the updated difference not satisfying the threshold condition, cause the power state of the image signal processor to be changed from the higher power state to the lower power state. In such an example, the computing device can alternatively or additionally comprise instructions executable to determine the threshold condition based at least on one or both of the quantification of the content of the first image or the quantification of the content of the second image. In such an example, the computing device can alternatively or additionally comprise instructions executable to convert the first image from a first color space to a second color space to obtain luminance values for the first image, wherein the quantification of the content of the first image can comprise a quantification of the luminance values. In such an example, the threshold condition can comprise a threshold change in a color value. In such an example, the quantification of the content of the first image can quantify a subset of the first image, and the quantification of the content of the second image can quantify a subset of the second image that spatially corresponds to the subset of the first image. In such an example, the instructions executable to preprocess the first image and preprocess the second image can be executable to produce a quantification of a binned pixel value produced by binning two or more adjacent pixel values. In such an example, the quantification of the content of the first image and the quantification of the content of the second image each can alternatively or additionally comprise a sum of two or more pixel values. In such an example, the quantification of the content of the first image and the quantification of the content of the second image can each alternatively or additionally quantify one or both of luminance in the first image or chrominance in the first image. In such an example, the computing device can alternatively or additionally comprise instructions executable to, responsive to the difference satisfying the threshold condition, forward subsequent images from the image sensor to the image signal processor for detecting a user presence. In such an example, the image sensor can be a first image sensor, and the computing device can alternatively or additionally comprise instructions executable to multiplex image data from the first image sensor and image data from a second image sensor to form multiplexed image data, and send the multiplexed image data to the image signal processor. In such an example, the computing device can alternatively or additionally comprise instructions executable to one or more of remove a defective pixel value from the content of the first image, determine autofocus statistics, determine autobalance statistics, determine autoexposure statistics, or remosaic the first image.

Another example provides, at a front-end preprocessor of a computing device, the front-end preprocessor disposed electrically between an image sensor and an image signal processor, a method, comprising receiving a first image from the image sensor, preprocessing the first image to produce a quantification of content of the first image, storing the quantification of the content of the first image, receiving a second image from the image sensor, preprocessing the second image to produce a quantification of content of the second image, comparing the quantification of the content of the second image to the quantification of content of the first image to determine a difference, and responsive to the difference satisfying a threshold condition, causing a power state of the image signal processor to be changed from a lower power state to a higher power state. In such an example, the method can alternatively or additionally comprise receiving a third image from the image sensor, preprocessing the third image to produce a quantification of content of the third image, receiving a fourth image from the image sensor, preprocessing the fourth image to produce a quantification of content of the fourth image, comparing the quantification of the content of the third image to the quantification of the content of the fourth image to determine an updated difference, and responsive to the updated difference not satisfying the threshold condition, causing the power state of the image signal processor to be changed from the higher power state to the lower power state. In such an example, the method can alternatively or additionally comprise determining the threshold condition based at least on one or both of the quantification of the content of the first image or the quantification of the content of the second image. In such an example, the method can alternatively or additionally comprise converting the first image from a first color space to a second color space to obtain luminance values for the first image, wherein the quantification of the content of the first image can comprise a quantification of the luminance values. In such an example, the method can alternatively or additionally comprise, responsive to the difference satisfying the threshold condition, forwarding subsequent images from the image sensor to the image signal processor for detecting a user presence. In such an example, the image sensor can be a first image sensor, and the method can alternatively or additionally comprise multiplexing image data from the first image sensor and image data from a second image sensor to form multiplexed image data, and sending the multiplexed image data to the image signal processor.

Another example provides a computing device comprising an image sensor, an image signal processor, a front-end preprocessor disposed electrically between the image sensor and the image signal processor, a logic subsystem, and a storage subsystem comprising instructions executable by the logic subsystem to receive a first image from the image sensor at the front-end preprocessor, convert the first image from a first color space to a second color space, preprocess the first image to produce a quantification of content of the first image in the second color space, store, at the front-end preprocessor, the quantification of the content of the first image, receive a second image from the image sensor at the front-end preprocessor, convert the second image from the first color space to the second color space, preprocess the second image to produce a quantification of content of the second image in the second color space, compare the quantification of the content of the second image to the quantification of content of the first image to determine a difference, and responsive to the difference satisfying a threshold condition, cause a power state of the image signal processor to be changed from a lower power state to a higher power state. In such an example, the computing device can alternatively or additionally comprise instructions executable to receive a third image from the image sensor at the front-end preprocessor, preprocess the third image to produce a quantification of content of the third image, receive a fourth image from the image sensor at the front-end preprocessor, preprocess the fourth image to produce a quantification of content of the fourth image, compare the quantification of the content of the third image to the quantification of the content of the fourth image to determine an updated difference, and responsive to the updated difference not satisfying the threshold condition, cause the power state of the image signal processor to be changed from the higher power state to the lower power state.

It will be understood that the configurations and/or approaches described herein are exemplary in nature, and that these specific examples are not to be considered in a limiting sense, because numerous variations are possible. The specific routines or methods described herein can represent one or more of any number of processing strategies. As such, various acts illustrated and/or described can be performed in the sequence illustrated and/or described, in other sequences, in parallel, or omitted. Likewise, the order of the above-described processes can be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing device, comprising:
an image sensor;
an image signal processor;
a front-end preprocessor disposed electrically between the image sensor and the image signal processor;
a logic subsystem; and
a storage subsystem comprising instructions executable by the logic subsystem to
receive a first image from the image sensor at the front-end preprocessor;
preprocess the first image to produce a quantification of content of the first image;
receive a second image from the image sensor at the front-end preprocessor;
preprocess the second image to produce a quantification of content of the second image;
compare the quantification of the content of the second image to the quantification of content of the first image to determine a difference; and
responsive to the difference satisfying a threshold condition, cause an operating state of a component of the computing device to be changed.

2. The computing device of claim 1, wherein the operating state is a power state of the image signal processor and is changed from a lower power state to a higher power state, and further comprising instructions executable to
receive a third image from the image sensor at the front-end preprocessor;
preprocess the third image to produce a quantification of content of the third image;
receive a fourth image from the image sensor at the front-end preprocessor;
preprocess the fourth image to produce a quantification of content of the fourth image;
compare the quantification of the content of the third image to the quantification of the content of the fourth image to determine an updated difference; and
responsive to the updated difference not satisfying the threshold condition, cause the power state of the image signal processor to be changed from the higher power state to the lower power state.

3. The computing device of claim 1, further comprising instructions executable to determine the threshold condition based at least on one or both of the quantification of the content of the first image or the quantification of the content of the second image.

4. The computing device of claim 1, further comprising instructions executable to convert the first image from a first color space to a second color space to obtain luminance values for the first image, wherein the quantification of the content of the first image comprises a quantification of the luminance values.

5. The computing device of claim 1, wherein the threshold condition comprises a threshold change in a color value.

6. The computing device of claim 1, wherein the quantification of the content of the first image quantifies a subset of the first image, and wherein the quantification of the content of the second image quantifies a subset of the second image that spatially corresponds to the subset of the first image.

7. The computing device of claim 1, wherein the instructions executable to preprocess the first image and preprocess the second image are executable to produce a quantification of a binned pixel value produced by binning two or more adjacent pixel values.

8. The computing device of claim 1, wherein the quantification of the content of the first image and the quantification of the content of the second image each comprises a sum of two or more pixel values.

9. The computing device of claim 1, wherein the quantification of the content of the first image and the quantification of the content of the second image each quantifies one or both of luminance in the first image or chrominance in the first image.

10. The computing device of claim 1, further comprising instructions executable to, responsive to the difference satisfying the threshold condition, forward subsequent images from the image sensor to the image signal processor for detecting a user presence.

11. The computing device of claim 1, wherein the image sensor is a first image sensor, further comprising instructions executable to multiplex image data from the first image sensor and image data from a second image sensor to form multiplexed image data, and send the multiplexed image data to the image signal processor.

12. The computing device of claim 1, further comprising instructions executable to one or more of remove a defective pixel value from the content of the first image, determine autofocus statistics, determine autobalance statistics, determine autoexposure statistics, or remosaic the first image.

13. At a front-end preprocessor of a computing device, the front-end preprocessor disposed electrically between an image sensor and an image signal processor, a method, comprising:
receiving a first image from the image sensor;
preprocessing the first image to produce a quantification of content of the first image;
storing the quantification of the content of the first image;
receiving a second image from the image sensor;
preprocessing the second image to produce a quantification of content of the second image;
comparing the quantification of the content of the second image to the quantification of content of the first image to determine a difference; and
responsive to the difference satisfying a threshold condition, causing a power state of the image signal processor to be changed from a lower power state to a higher power state.

14. The method of claim 13, further comprising:
receiving a third image from the image sensor;
preprocessing the third image to produce a quantification of content of the third image;
receiving a fourth image from the image sensor;
preprocessing the fourth image to produce a quantification of content of the fourth image;
comparing the quantification of the content of the third image to the quantification of the content of the fourth image to determine an updated difference; and
responsive to the updated difference not satisfying the threshold condition, causing the power state of the image signal processor to be changed from the higher power state to the lower power state.

15. The method of claim 13, further comprising determining the threshold condition based at least on one or both of the quantification of the content of the first image or the quantification of the content of the second image.

16. The method of claim 13, further comprising converting the first image from a first color space to a second color space to obtain luminance values for the first image, wherein the quantification of the content of the first image comprises a quantification of the luminance values.

17. The method of claim 13, further comprising, responsive to the difference satisfying the threshold condition, forwarding subsequent images from the image sensor to the image signal processor for detecting a user presence.

18. The method of claim 13, wherein the image sensor is a first image sensor, further comprising multiplexing image data from the first image sensor and image data from a second image sensor to form multiplexed image data, and sending the multiplexed image data to the image signal processor.

19. A computing device, comprising:
an image sensor;
an image signal processor;
a front-end preprocessor disposed electrically between the image sensor and the image signal processor;
a logic subsystem; and
a storage subsystem comprising instructions executable by the logic subsystem to
receive a first image from the image sensor at the front-end preprocessor;
convert the first image from a first color space to a second color space;
preprocess the first image to produce a quantification of content of the first image in the second color space;
store, at the front-end preprocessor, the quantification of the content of the first image;
receive a second image from the image sensor at the front-end preprocessor;
convert the second image from the first color space to the second color space;
preprocess the second image to produce a quantification of content of the second image in the second color space;
compare the quantification of the content of the second image to the quantification of content of the first image to determine a difference; and
responsive to the difference satisfying a threshold condition, cause a power state of the image signal processor to be changed from a lower power state to a higher power state.

20. The computing device of claim 19, further comprising instructions executable to receive a third image from the image sensor at the front-end preprocessor;
preprocess the third image to produce a quantification of content of the third image;
receive a fourth image from the image sensor at the front-end preprocessor;
preprocess the fourth image to produce a quantification of content of the fourth image;
compare the quantification of the content of the third image to the quantification of the content of the fourth image to determine an updated difference; and
responsive to the updated difference not satisfying the threshold condition, cause the power state of the image signal processor to be changed from the higher power state to the lower power state.
